(19) United States
(12) Patent Application Publication
(10) Pub. No.: US 2024/0364642 A1
(43) Pub. Date: Oct. 31, 2024

(54) SYSTEMS AND METHODS OF PACKET-BASED COMMUNICATION

(71) Applicant: MELLANOX TECHNOLOGIES, LTD., Yokneam (IL)

(72) Inventors: Elena Agostini, Rome (IT); Brent David Schartung, Plano, TX (US); Wei Zhang, Cedar Park, TX (US)

(21) Appl. No.: 18/512,961

(22) Filed: Nov. 17, 2023

Related U.S. Application Data
(60) Provisional application No. 63/461,794, filed on Apr. 25, 2023.

(51) Int. Cl. H04L 49/90; H04L 69/22

(52) U.S. Cl. CPC H04L 49/90; H04L 69/22

(57) ABSTRACT

A system for transmitting data is described, among other things. An illustrative system is disclosed to include one or more circuits to perform receiving a first packet, determining a header of the first packet includes a SYN, FIN, or RST flag, in response, delivering the first packet to a CPU, receiving a second packet, determining a header of the second packet does not include a SYN, FIN, or RST flag, and, in response, deliver the second packet to a GPU.

### CROSS-REFERENCE TO RELATED APPLICATION

The present application claims the benefit of and priority, under 35 U.S.C. § 119, to U.S. Provisional Application No. 63/461,794, filed Apr. 25, 2023, entitled “SYSTEMS AND METHODS OF PACKET-BASED COMMUNICATION” the entire disclosure of which is hereby incorporated herein by reference, in its entirety, for all that it teaches and for all purposes.

### FIELD OF THE DISCLOSURE

The present disclosure is generally directed to systems, methods, and devices for transmitting data and, in particular, for enabling transmission control protocol (TCP) communication between a peer and a graphics processing unit (GPU).

### BACKGROUND

GPU-accelerated applications offload time-consuming routines and functions to run on one or more GPUs and take advantage of massive parallelism. Applications executing on client devices, such as research computers and computers executing AI-related applications, rely on computing systems including a GPU to perform complex tasks in a timely manner. The faster such computing systems are able to handle tasks, the more advancements may be made in the fields of research.

Conventional applications executing on client devices rely on TCP communication for sending data to computing systems for processing. However, TCP requires a communication session to be established before packets can be sent and received. Conventional computing systems are not capable of handling TCP connections fast enough to meet the demands of users such as researchers.

As should be appreciated, the technical shortcomings of conventional computing systems negatively affect real-world applications involving, for example, scientific research.

### SUMMARY

Typically, when a computing device sends and receives packets, the computing device includes a memory device and a central processing unit (CPU) in communication with a network interface card (NIC). During a communication using a TCP connection, the CPU instructs the NIC to receive and/or send packets stored in a particular location of the memory device. Conventional computing systems are limited with regard to speed when communicating via a TCP connection. Using a system or method as described herein, a computing device is enabled to connect to one or more TCP peers and handle packets in parallel at a faster rate as compared to conventional computing devices.

Because of the three-way handshake required to establish a TCP connection, current methods of communicating via TCP require using a CPU, which has limited parallel computing capacity as compared to a GPU. What is needed is a way to handle TCP packets from a plurality of TCP peers without requiring a CPU to handle each packet.

Using a system and method as described herein, a bulk of TCP packets in a TCP connection can be received and processed using a GPU without involving a CPU. Similarly, using a system and method as described herein, packets may be sent from a GPU to a TCP peer without involving a CPU.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

The present disclosure is described in conjunction with the appended figures, which are not necessarily drawn to scale:

FIG. 1 is a block diagram of an environment in accordance with one or more of the embodiments described herein;

FIG. 2 is a block diagram of a computing system in accordance with one or more of the embodiments described herein;

FIG. 3 is a block diagram of a packet in accordance with one or more of the embodiments described herein; and

FIG. 4 is a flowchart of a method in accordance with one or more of the embodiments described herein.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The details of one or more aspects of the disclosure are set forth in the accompanying drawings and the description below. Other features, objects, and advantages of the techniques described in this disclosure will be apparent from the description and drawings, and from the claims.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The preceding Summary is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

It will be appreciated from the following description, and for reasons of computational efficiency, that the components of the system can be arranged at any appropriate location within a distributed network of components without impacting the operation of the system.

Further, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The terms “determine,” “calculate,” and “compute,” and variations thereof, as used herein, are used interchangeably, and include any appropriate type of methodology, process, operation, or technique.

Various aspects of the present disclosure will be described herein with reference to drawings that may be schematic illustrations of idealized configurations.

Any of the steps, functions, and operations discussed herein can be performed continuously and automatically.

Systems and methods of this disclosure are described in relation to a network of switches; however, to avoid unnecessarily obscuring the present disclosure, the description omits a number of known structures and devices. Such omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases may not necessarily refer to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The use of GPUs as a means to offload computationally-intensive tasks from CPUs is increasingly important to users such as scientific researchers seeking to execute artificial intelligence (AI) models and other computationally-intensive processes.

The growing demand for high-performance computing in various domains, including scientific simulations, machine learning, and image processing, has driven the need for efficient and cost-effective computational resources. The limitations of CPU performance and the increasing importance of parallelism have prompted researchers and other users to explore alternatives to the use of CPUs for performing data processing. As a result, GPUs have emerged as an approach to offload computationally-intensive tasks from CPUs.

Offloading processes from CPUs to GPUs can provide several benefits, particularly for tasks that involve complex computations or large-scale data processing.

GPUs are designed for parallel processing and are capable of performing computations simultaneously. The architecture of a GPU is well-suited for tasks involving large-scale data processing or complex mathematical operations, such as image processing or deep learning, leading to significant performance improvements as compared to executing the same tasks on a CPU.

Also, GPUs are generally more power-efficient than CPUs when performing parallel computations. The per-core power consumption of a GPU is lower than that of a CPU. As a result, offloading processes from a CPU to a GPU as described herein enables energy savings.

Offloading processes to GPUs can accelerate scientific simulations and research in fields such as physics, chemistry, and biology by enabling faster computations, which can lead to more accurate results and quicker discoveries. Offloading graphics-related tasks to GPUs allows for better rendering performance and improved visual quality in gaming and other graphics-intensive applications. Offloading processes to GPUs can accelerate machine learning and AI workloads, particularly deep learning tasks involving large neural networks. The parallel processing capabilities of GPUs can lead to faster training and inference times, enabling quicker iteration and deployment of AI models.

Offloading computationally-intensive tasks from a CPU to a GPU allows the CPU to focus on other tasks, such as managing system resources, handling user inputs, and executing other applications. This leads to improved overall system performance and responsiveness.

As should be appreciated, offloading tasks from a CPU to one or more GPUs can result in substantial performance improvements and other benefits.

Data Plane Development Kit (DPDK) and Data Center-on-a-Chip Architecture (DOCA™) are software development tools designed to enhance the performance and efficiency of network applications.

DPDK is an open-source software library that provides a set of libraries and drivers that enable faster packet processing in the data center. DPDK provides a framework for the development of high-performance networking applications, such as firewalls, load balancers, and routers. DPDK uses a polling mechanism to bypass an operating system (OS), allowing a computing system to handle more packets with lower latency and higher throughput.

DOCA is a software development kit (SDK) providing an application programming interface (API) for building advanced networking applications. DOCA provides a set of libraries and drivers that work with networking devices, such as NICs or network interface controllers, SmartNICs, and ethernet switches. DOCA enables developers to create applications that can offload network functions from the CPU to the networking device, improving the performance and efficiency of, for example, data centers.

Together, DPDK and DOCA provide a set of tools for optimizing the performance and efficiency of data center infrastructure. By enabling faster packet processing and offloading network functions to specialized hardware, these tools can help data centers to achieve higher throughput, lower latency, and better scalability.

DPDK and DOCA enable a complete bypass of the OS kernel. This enables a computing system as described herein to perform the three-way handshake without involving, or absent of, the OS socket.

DOCA enables a NIC of a computing system to redirect traffic. Through DOCA, flow steering rules can be imposed to select one or more receive queues in which to receive particular types of traffic. While systems and methods described herein relate to the use of DOCA to create steering rules, it should be appreciated that other techniques may be used, such as DPDK. As such, the systems and methods described herein should not be considered as limited to using DPDK to create steering rules.

By using a system or method as described herein, TCP connections and communications may be managed without relying on an OS socket. Instead, through the systems and methods described herein, the OS kernel is bypassed. The disclosed systems and methods enable a NIC of a computing system to enable direct communication between each of a GPU and a CPU of the computing system with a TCP peer. By avoiding the OS socket as described herein, the systems and methods reduce latency and provide more control to users.

A computing system as described herein may utilize work queue entries (WQEs) and completion queue entries (CQEs) to provide direct access to NIC hardware for an application, enabling the application to communicate with peers independently of the OS kernel. Bypassing the OS kernel reduces the overhead and latency associated with handling data processing for peers as described herein.

CQEs may be used by the computing system to track the status and results of completed operations. When a task has been executed by the NIC, a corresponding CQE may be generated to indicate the completion of the task. In this way, applications are enabled to efficiently manage and process the results of their network operations without the need for interaction with the OS.

The computing system may in some embodiments implement a doorbell mechanism to trigger the NIC to start processing WQEs. When a CPU or GPU of the system posts a WQE, the doorbell may be rung by writing a value to, for example, a register on the NIC. When the doorbell is rung, the NIC is informed that new WQEs are available for processing, enabling direct communication between the application and the hardware, and further reducing overhead and latency.

As should be appreciated, WQEs, CQEs, and the doorbell mechanism enable applications to effectively bypass the OS kernel, leveraging the performance benefits of DPDK for efficient and high-speed packet processing in networking applications.

Some applications executed by user devices rely on TCP for communication as TCP ensures reliable, accurate, and ordered data transfer. Applications which rely on TCP include, for example, applications relating to file transfer, email, web browsing, financial transactions, and remote desktop sessions. By using TCP, such applications are empowered with data integrity, flow control, and connection-oriented communication.

However, the use of TCP for communication requires communication sessions to be managed. For example, TCP requires a three-way handshake for initiation and, at the end of the communication, a termination of the communication. Using conventional systems, the management of a TCP connection is handled by an OS socket.

A TCP three-way handshake is a process which establishes a connection between a peer, such as a web browser or other application executing on a client device, and a computing system, such as a server. The handshake may begin with the peer sending a synchronize (SYN) packet to the computing system, requesting to initiate the connection. The computing system may respond with a synchronize-acknowledge (SYN-ACK) packet, confirming the receipt of the SYN request and requesting to establish the connection with the peer. Finally, the peer may acknowledge the SYN-ACK from the computing system by sending an acknowledge (ACK) packet. Upon the computing system receiving the ACK packet, the TCP connection is established between the peer and the computing system, allowing for reliable and ordered data exchange.

While DOCA and DPDK enable communication between a CPU or a GPU and a network node for UDP and other non-connection-based protocols, connection-based protocols such as TCP present a technological problem in that the three-way handshake and other processes for managing the TCP connection are required. By using a system or method as described herein, however, connection-based protocols such as TCP can be used to provide communication between CPUs and GPUs and peers.

The systems and methods described herein avoid utilizing cycles of a GPU for TCP connection management processes, such as performing a three-way handshake, while enabling the GPU to communicate directly with a peer over TCP. Once a TCP connection is established, packets associated with the TCP connection may be automatically sent directly to the GPU. As a result, using a system or method as described herein, the GPU is enabled to focus on signal processing, network filtering, and/or other computationally-intensive tasks. Furthermore, a large number of TCP peers may be enabled to communicate with the computing system via the GPU as the GPU is designed to handle parallel processing.

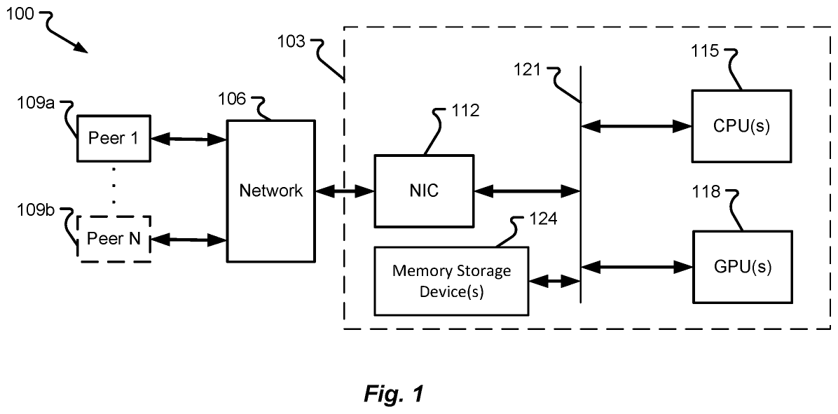

Reference is made to FIG. 1, showing a nonlimiting block diagram of an exemplary computing environment 100 in accordance with one or more embodiments. The environment 100 may include one or more peers 109a-b communicating with a computing system 103 via a network 106.

The computing system 103 may include one or more CPUs 115, one or more GPUs 118, and one or more NICs 112. Each of the CPUs 115, GPUs 118, and NICs 112 may communicate via a bus 121.

A NIC 112 of the computing system 103 may comprise one or more circuits capable of acting as an interface between components of the computing system 103, such as the CPU 115 and the GPU 118, and the network 106. The NIC 112 may enable data transmission and reception such that peers 109a-b may communicate with the computing system 103. A NIC 112 may comprise one or more of a peripheral component interconnect express (PCIe) card, a USB adapter, and/or may be integrated into a PCB such as a motherboard. The NIC 112 may be capable of supporting any number of network protocols such as Ethernet, Wi-Fi, fiber channel, etc.

As described herein, the NIC 112 may be capable of receiving packets from one or more peers 109a-b via the network 106. The NIC 112 may process a header of each received packet to determine whether each packet should be handled by the CPU 115 or the GPU 118.

The NIC 112 may be in direct communication with each of the GPU(s) 118 and the CPU(s) 115 via the bus 121 as well as in external communication with the network 106 via, for example, Ethernet in combination with TCP.

One or more CPUs 115 of the computing system 103 may each comprise one or more circuits capable of executing instructions and performing calculations. The CPUs 115 may be capable of interpreting and processing data received by the computing system 103 via the NIC 112. The CPUs 115 may each comprise one or more arithmetic logic units (ALUs) capable of performing arithmetic and/or logical operations, such as addition, subtraction, and bitwise operations. The CPUs 115 may also or alternatively comprise one or more control unit (CUs) which may be capable of managing the flow of instructions and data within the CPU 115. CUs of the CPU 115 may be configured to fetch instructions from memory 215, decode the instructions, and direct appropriate components to execute operations based on the instructions.

A CPU 115 of the computing system 103 may include, for example, a CPU, a reduced instruction set computing (RISC) processor, a complex instruction set computing (CISC) processor, a GPU, a digital signal processor (DSP) such as a baseband processor, an application-specific integrated circuit (ASIC), a field-programmable gate array (FPGA), a radio-frequency integrated circuit (RFIC), another processor (including those discussed herein), or any suitable combination thereof. Similarly, a GPU 118 as described herein may include a CPU, a RISC processor, a CISC processor, a DSP, a baseband processor, an ASIC, an FPGA, an RFIC, another processor (including those discussed herein), or any suitable combination thereof.

A CPU 115 as described herein may incorporate multiple processing cores, allowing the CPU 115 to execute multiple instructions simultaneously, and/or may be capable of performing hyperthreading to execute multiple threads concurrently.

One or more GPUs 118 of the computing system 103 may each comprise one or more circuits capable of acting as specialized processing components to handle computationally-intensive tasks, such as rendering graphics and performing complex mathematical calculations. GPUs 118 may be capable of parallel execution of general-purpose tasks alongside the CPUs 115.

Each GPU 118 may comprise one or more streaming multiprocessors (SMs), CUs, or processors 212, which may be responsible for executing instructions in parallel. Each SM, CU, or processor 212 of a GPU 118 may contain one or more processing cores or ALUs which may be capable of performing arithmetic and/or logical operations concurrently.

Each GPU 118 of the computing system 103 may be capable of executing tasks such as scientific simulations, machine learning, and data analysis. For example, a GPU 118 of the computing system 103 may be designed for operation in workstation environments, such as for performing scientific simulations, executing and/or training machine learning models, performing data analysis, etc.

The GPU 118 may execute one or more kernels. Kernels executed by the GPU 118 may perform specific, parallelizable tasks on the GPU 118. Such kernels may be written using GPU programming languages or frameworks, such as compute unified device architecture (CUDA).

The bus 121 of the computing system 103 may comprise one or more circuits capable of connecting peripheral devices such as the NIC 112, one or more GPUs 118, and one or more CPUs 115 to a motherboard of the computing system 103, as well as one or more memory storage devices 124. The bus 121 of the computing system 103 may comprise one or more high-speed lanes. Each lane may be, for example, a serial lane, and may consist of a pair of signaling wires for transmitting and/or receiving data. The bus 121 may be, for example, a PCIe bus.

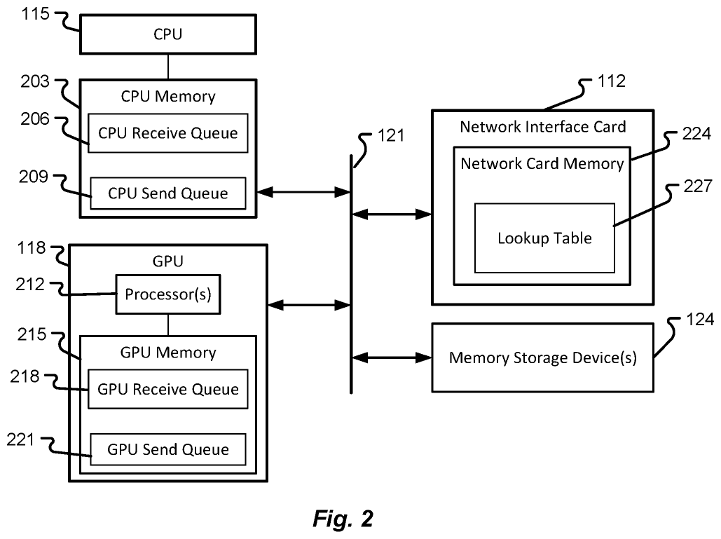

The computing system 103 may further comprise one or more memory storage devices 124, such as non-volatile memory (NVM) Express (NVMe) solid-state drives (SSDs). The memory storage devices 124 may be capable of providing fast and efficient data access and storage. Each of the NIC 112, CPU 115, and GPU 118 may be capable of sending data to and reading data from the memory storage devices 124 via the bus 121. Each of the NIC 112, the CPU 115, and the GPU 118 may also comprise one or more dedicated memory devices. Such memory storage devices may be as illustrated in FIG. 2 and described below.

The one or more peers 109a-b may connect to the computing system 103 to access shared resources, services, and data, via the network 106. The peers 109a-b may be, for example, client devices such as personal computers, laptops, smartphones, and Internet of Things (IoT) devices, capable of sending data to and receiving data from the computing system 103 over the network 106.

Each of the peers 109a-b may comprise network interfaces including, for example, a transceiver. Each peers 109a-b may be capable of receiving and transmitting packets in conformance with applicable protocols such as TCP, although other protocols may be used. Each peers 109a-b can receive and transmit packets to and from network 106.

In some implementations, one or more peers 109a-b may be switches, proxies, gateways, load balancers, etc. Such peers 109a-b may serve as intermediaries between clients and/or servers, relaying or modifying the communication between the clients and/or servers.

In some implementations, one or more peers 109a-b may be IoT devices, such as sensors, actuators, and/or embedded systems, connected to the networks 106. Such IoT devices may act as clients, servers, or both, depending on implementations and the specific IoT applications. For example, a first peer 109a may be a smart thermostat acting as a client, a second peer 109b may be a central server for analysis or a smartphone executing an app.

The network 106 may rely on various networking hardware and protocols to establish communication between the peers 109a-b and the computing system. Such infrastructure may include one or more routers, switches, and/or access points, as well as wired and/or wireless connections.

Network 106 may be, for example, a local area network (LAN) connecting peers 109a-b with the computing system 103. A LAN may use Ethernet or Wi-Fi technologies to provide communication between the peers 109a-b with the computing system 103.

In some implementations, the network 106 may be, for example, a wide area network (WAN) and may be used to connect peers 109a-b with the computing system 103. A WAN may comprise, for example, one or more of lines, satellite links, cellular networks. WANs may use various transmission technologies, such as leased lines, satellite links, or cellular networks, to provide long-distance communication. A TCP connection over a WAN may be used, for example, to enable peers 109a-b to communicate reliably with the computing system 103 across vast distances.

In some implementations, network 106 may comprise the Internet, one or more mobile networks, such as 4G, 5G, LTE, virtual networks, such as a VPN, or some combination thereof.

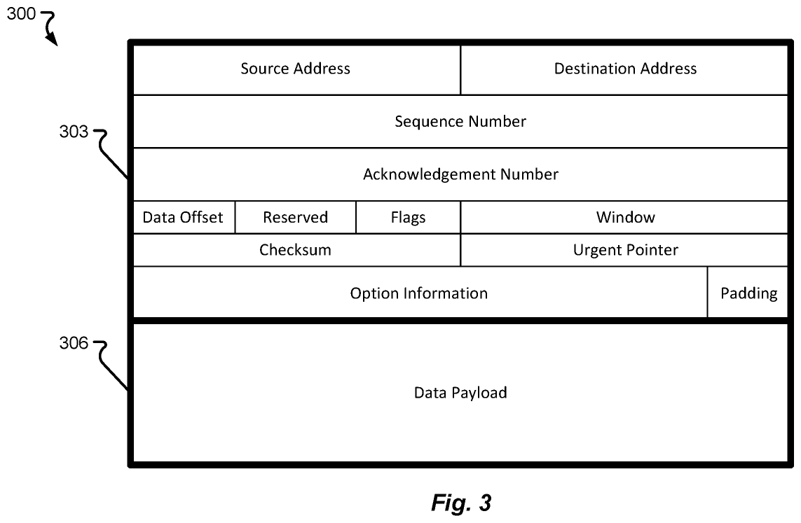

Data sent between the peers 109a-b and the computing system 103 over the network 106 may utilize TCP. As described herein, when sending data over the network 106, a TCP connection is established between a particular peer 109a-b and the computing system 103. Once the connection is made, data is exchanged in the form of packets, such as a packet 300 as illustrated in FIG. 3 and described in greater detail below.

As should be appreciated, the peers 109a-b may be client devices and may encompass a wide range of devices, including desktop computers, laptops, smartphones, IoT devices, etc. Such peers 109a-b may execute one or more applications which communicate with the computing system 103 to access resources or services. For example, a peer 109a may execute a web browser and the computing system 103 may act as a web server. The computing peer 109a may communicate with the web server to request and display web content. As another example, the peer 109a may execute a file-sharing application and the computing system 103 may act as a file server. The peer 109a may communicate with the file server to upload or download files. As another example, the computing system 103 may act as an AI server capable of being used by a peer 103a to offload computationally-intensive processes for execution in parallel by one or more GPUs 118 of the computing system 103. Applications running on the peers 109a-b may be responsible for initiating communication with the computing system 103, making requests for resources or services, and processing data received from the computing system 103. The network 106 may enable the computing system 103 to communicate any number of concurrent communications with any number of peers 109a-b simultaneously.

It should also be appreciated that in some embodiments, the systems and methods described herein may be executed without a network 106 connection. For example, one or more peers 109a-b may be capable of communicating directly with the computing system 103 without relying on any particular network 106.

FIG. 2 is a block diagram illustrating components of a computing system 103 which, according to some example implementations, may be capable of performing any one or more of the methods discussed herein. As illustrated in FIG. 2, each of the NIC 112, CPU 115, GPU 118, may comprise or be in communication with one or more memory storage devices 224, 203, 215, capable of storing queues of packets and/or other data.

The queues stored and read by each of the NIC 112, CPU 115, and GPU 118 may be configurable based on user settings. For example, user settings may enable one GPU receive queue for a plurality of peers 109a-b or a separate GPU receive queue for each peer 109a-b. Such settings may be programmable through the NIC 112.

Each of the one or more CPUs 115 of the computing system 103 may be responsible for processing instructions and managing data communication within the computing system 103. To effectively handle incoming and outgoing data, the CPUs 115 may utilize one or more receive queues 206 and send queues 209, which may be stored in, for example, one or more CPU memory structures 203 capable of storing data temporarily before the data is processed or transmitted.

A CPU receive queue 206, may be used by the NIC 112 to store incoming data packets from peers 109a-b until the CPU 115 is ready to process the packets. Similarly, a CPU send queue 209 may be used by the CPU 115 to store data packets generated by the CPU 115 before the data packets are transmitted to peers 109a-b via the NIC 112.

Each of the one or more GPUs 118 of the computing system 103 may also be responsible for processing instructions within the computing system 103. To effectively handle incoming and outgoing data, the GPUs 118 may utilize one or more receive queues 218 and send queues 221, which may be stored in, for example, one or more GPU memory structures 215 capable of storing data temporarily before the data is processed or transmitted.

A GPU receive queue 218, may be used by the NIC 112 to store incoming data packets from peers 109a-b until one or more processors 212 of the GPU 118 are ready to process the packets. Similarly, a GPU send queue 221 may be used by the GPU 118 to store data packets generated by the one or more processors 212 of the GPU 118 before the data packets are transmitted to peers 109a-b via the NIC 112.

The NIC 112 may comprise or be in communication with one or more network card memory devices 224. The network card memory devices 224 may be used to store one or more lookup tables 227.

A lookup table 227 may be accessible by one or both of the CPU 115 and the NIC 112. As described in greater detail below, upon completing a three-way handshake to initiate a TCP connection, the CPU 115 may be capable of writing an entry to the lookup table 227. Upon completing a termination of a TCP connection, the CPU 115 may be capable of removing an entry from the lookup table 227.

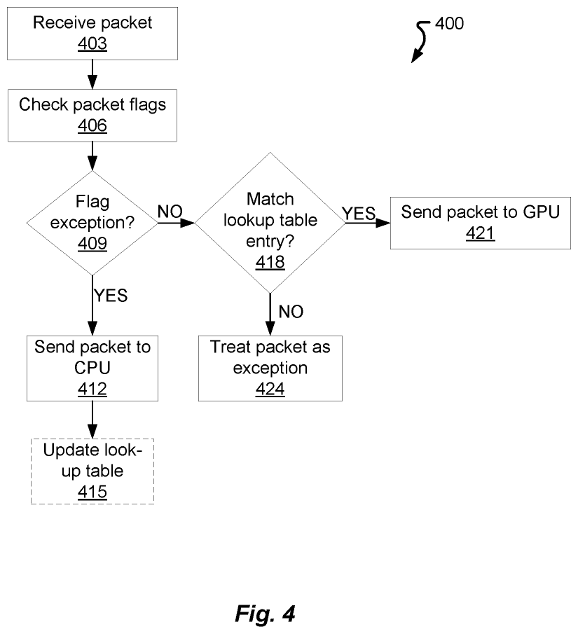

The NIC 112 may be capable of comparing data stored within packets received from peers with information in the lookup table 227 to determine whether a TCP connection for the packet is currently initiated. Such a process may be as described below in relation to the method 400 illustrated in FIG. 4.

A lookup table 227 may be as illustrated below in Table 1. As should be appreciated, the source addresses and destination addresses listed in the Table are examples for illustration purposes only.

TABLE 1

| Source Address | Destination Address |
|---|---|
| 1.1.1.1 | 2.2.2.2 |
| 2.2.2.2 | 1.1.1.1 |
| 3.3.3.3 | 1.1.1.1 |
| 4.4.4.4 | 2.2.2.2 |
| 4.4.4.4 | 3.3.3.3 |
| 4.4.4.4 | 5.5.5.5 |

In some embodiments, the lookup table 227 may comprise a list of entries. Each entry may comprise information such as, but not limited to, a destination address, a source address, an IP address, a port number, mac address, or other information. The information stored in each entry in the lookup table 227 may be used by the NIC 112 to determine whether a packet matching the information is associated with an initiated communication.

Each peer associated with an initiated communication may be represented as an entry in the lookup table. In this way, the NIC 112 may be capable of determining whether a received packet is associated with an initiated communication. As described below in relation to the method 400 illustrated in FIG. 4, if a packet (1) does not contain one or more of a synchronize (SYN) flag, a reset (RST) flag, and/or a finish (FIN) flag, and (2) is associated with an entry in the lookup table 227, the NIC 112 may send the packet directly to the GPU receive queue 218 for processing by the GPU 118. Alternatively, if the packet does contain one or more of a SYN, RST, or FIN flag, the NIC 112 may send the packet to the CPU receive queue 206 for processing by the CPU 115. Finally, if a received packet does not contain one or more of a SYN, RST, or FIN flag, the packet may be treated by the NIC 112 as an exception and the packet may be dropped.

When a new communication is initiated, such as when the CPU 115 handles a packet containing a SYN flag, an entry for the communication may be added to the lookup table 227. In some embodiments, adding an entry to the lookup table 227 may comprise the CPU 115 sending an instruction to the NIC 112 to add the entry. The instruction to the NIC 112 to add the entry may be in the form of a packet and may comprise information such as a destination address and/or a source address for the communication and an indication that the communication is initiated. As a result, future packets from a remote peer 109 relating to the TCP communication session may be sent directly to the GPU receive queue 218, unless the packet contains either a SYN, FIN, or RST flag.

Similarly, when a communication is terminated, such as when the CPU handles a packet containing a FIN or RST flag, an entry for the communication may be removed from the lookup table 227. In some embodiments, removing an entry from the lookup table 227 may comprise the CPU 115 sending an instruction to the NIC 112 to remove the entry. The instruction to the NIC 112 to remove the entry may be in the form of a packet and may comprise information such as a destination address and/or a source address for the communication and an indication that the communication is terminated. As a result, future packets from a remote peer relating to the terminated TCP communication session may be treated by the NIC 112 as an exception and not sent to the GPU receive queue 218, unless the packet contains either a SYN, FIN, or RST flag. As a result, future packets from a remote peer 109 relating to the TCP communication session will not reach the GPU 118 outside the scope of the TCP communication session.

In addition to storing the lookup table 227, the network card memory 224 or other memory devices comprised by or in communication with the NIC 112 may be capable of providing buffer memory to the NIC 112 and/or enabling the NIC 112 to write to one or more of receive and send queues.

While the CPU send and receive queues 209, 206, the GPU send and receive queues 221, 218, and the look-up table 227 are illustrated as being stored within one of CPU memory 203, GPU memory 215, and network card memory 224, it should be appreciated each of the queues, lookup tables, etc., may be stored anywhere within the computing system 103, such as within one or more memory storage devices 124 which may be accessible to one or more of the CPU 115, GPU 118, and NIC 112 via the bus 121.

The memory and/or storage devices illustrated in FIG. 2 may include, for example, main memory, disk storage, or any suitable combination thereof. The memory and/or storage devices may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The memory and/or storage devices of the computing system 103 may store instructions such as software, a program, an application, or other executable code for causing at least any of the CPU 115, the GPU 118, and the NIC 112 to perform, alone or in combination, any one or more of the methods discussed herein. The instructions may in some implementations reside, completely or partially, within at least one of the memory/storage devices illustrated in FIG. 2, or any suitable combination thereof.

In some embodiments, the electronic device(s), network(s), system(s), chip(s), circuit(s), or component(s), or portions or implementations thereof, of FIGS. 1 and 2, or some other figure herein, may be configured to perform one or more processes, techniques, or methods as described herein, or portions thereof. Such processes may be as depicted in FIG. 4 and as described below.

A packet 300, such as a TCP packet, which may also be known as a TCP segment, is a basic unit of data transmitted between nodes 109a, 109b and the computing system 103 in a data connection such as a TCP connection. A packet 300 may consist of two main components: a header 303 and a data payload 306. FIG. 3 illustrates components of a packet 300 in accordance with one or more of the implementations described herein. It should be appreciated that in some embodiments, a packet 300 may comprise greater or fewer elements than those illustrated in FIG. 3.

A header of a packet 300 may contain information required for the proper functioning of the protocol. For a TCP packet 300, the header 303 may have a minimum size of 20 bytes and can be up to 60 bytes long, for example, depending on the number and size of optional fields.

The header of the packet 300 may include fields including, but not limited to, an indication of a source port, such as a source address and/or port number, an indication of a destination, such as a destination address and/or port number, a sequence number, an acknowledgement number, data offset information, reserved bits, one or more flags, a window size, a checksum value, an urgent pointer, option information, and optionally padding.

Flags stored in the packet 300 may comprise one or more flags defined by the TCP specification, including, but not limited to SYN, FIN, and RST flags. Such flags may be used by a NIC 112 to determine the purpose of the packet in the context of connection management. A SYN flag may be used during the initial establishment of a TCP connection, indicating a request to synchronize sequence numbers and initiate communication between the computing system 103 and a remote peer 109a. A SYN flag may be present in the first step of the three-way handshake process, allowing the peer 109 and computing system 103 to agree on initial sequence numbers and establish a connection. A FIN flag may signify the peer's intention to close or terminate the connection. When a peer 109a sends a packet 300 with the FIN flag set in the header 303, the peer 109a indicates that the peer 109a has finished transmitting data and is ready to terminate the connection. Both the peer 109a and the computing system 103 may exchange FIN packets during the connection termination process. An RST flag may be used to reset an existing connection, for example due to an error, unavailability, or a security issue. When the NIC 112 receives a packet 300 with the RST flag set in the header 303, the NIC 112 may transmit the packet 300 to the CPU receive queue 206 so that the CPU 115 may terminate and re-initiate the connection.

The option information field of the packet 300 may be of a variable length and may contain optional information, such as maximum segment size, window scaling, or selective acknowledgments.

The data payload 306 of the packet is the actual data being transmitted between the sender and the receiver. The payload may follow the header and may vary in size, depending on the maximum segment size and the amount of data being transmitted.

A method 400 providing TCP packets to be handled by either a CPU 115 or a GPU 118 of a computing system without involving an OS socket is described herein and illustrated in FIG. 4.

Prior to the method 400, an initial setup phase may be performed to prepare the NIC 112, prepare the computing system 103, create or initialize any receive queues, create, or initialize any send queues, set features, capabilities, attributes, configurations, etc.

A CUDA kernel may be launched in the GPU 118. The CUDA kernel may be a function executing on the GPU and may provide the GPU with functions which may be used by the GPU to invoke send and receive. As a result, once a packet is received by the GPU receive queue, the packet may be processed by the GPU. The CUDA kernel can enable the GPU to, in parallel, receive from multiple queues and pass packets to other kernels which may be responsible for packet processing.

At 403, a packet 300 is received by a NIC 112 of the computing system 103. As described herein, the packet 300 may be sent to the computing system 103 by a peer 109a via a network 106. Upon reaching the computing system 103, the packet 300 may be received by the NIC 112.

At 406, the NIC 112 may inspect the packet to determine whether the packet 300 contains a header 303. It should be appreciated that in some embodiments, determining whether the packet 300 contains a header 303 may not be necessary.

If the packet 300 contains no header 303, the method 400 may not be necessary as the packet may not be a TCP packet, thus no three-way handshake may be necessary, and the packet may be handled via other means or dropped.

If the packet 300 does contain a header, the method 400 may continue. Next, at 409, the NIC 112 may inspect the header 303 to detect whether any of the FIN, RST, or SYN, flags are present, i.e., whether there is a flag exception.

The NIC 112 may be capable of inspecting the header 303 to recognize any flags in the headers 303. By inspecting the header 303, the NIC 112 may determine whether the header 303 contains one or more of a FIN, RST, and SYN flag.

If the header 303 of the packet 300 does contain one or more of a FIN, RST, and SYN flag, at 412 the NIC 112 may deliver the packet 300 to a receive queue 206 accessible by a CPU 115 of the computing system. As a result, the packet 300 may be added to the CPU receive queue 206. Next, the CPU 115 may handle the packet 300 as described below.

If the header 303 of the packet 300 does not contain one or more of a FIN, RST, and SYN flag, at 418, the NIC 112 may check whether packet 300 matches an entry in a lookup table 227 by comparing one or both of a source address and a destination address stored in the packet header 303 with entries in the lookup table 227.

Packets 300 contain headers 303 which include information linking each packet to a particular communication. Such information may include, for example, a source address and a destination address. Because packets 300 associated with different communications are distinguishable, the computing system 103 may be enabled to communicate with any number of peers and the NIC 112 of the computing system 103 can recognize the communication with which each packet is associated.

If information stored in the packet header 303 matches a lookup table entry, the NIC 112 may, at 421, deliver the packet 300 to a GPU receive queue 218 accessible by a GPU 118. As a result, the packet 300 may be added to the GPU receive queue 218. Next, the GPU 118 may handle the packet 300 as described below.

If the information stored in the packet header 303 does not match a lookup table 227 entry, the NIC 112 may, at 424, treat the packet 300 as exception and the packet 300 may be dropped.

As described above, if a packet 300 received by the NIC 112 contains a header 303 and the header 303 contains one or more of a SYN, FIN, and RST flag, the NIC 112 may store the packet 300 in a CPU receive queue 206.

The CPU 115 may be enabled to access the packet 300 stored in the CPU receive queue 206 and inspect the packet header 303 to determine (1) the identity of the peer from which the packet was sent; and (2) whether the peer is initiating or terminating a session.

Next, the CPU 115 may create an appropriate response packet to send to the peer 109 from which the packet 300 was sent to further the initiation or termination of the session.

The CPU 115 may transmit the response to the peer 109 through the NIC 112, such as by storing the response in a CPU send queue 209.

Next, at 415 of the method 400, the CPU 115 may update the lookup table 227. For example, if a new communication has been initiated, the CPU 115 may create a new entry in the lookup table 227 or instruct the NIC 112 to create the new entry in the lookup table 227. In this way, any future packets relating to the communication session may be directed by the NIC 1112 to the GPU 118 unless a FIN, RST, or SYN flag is present in the future packet.

If, on the other hand, the CPU 115 is terminating an initiated communication, the CPU 115 may remove an entry identifying the communication in the lookup table 227 or instruct the NIC 112 to remove the entry identifying the communication in the lookup table 227. In this way, any future packets relating to the terminated communication session may not be directed by the NIC 112 to the GPU 118 unless a FIN, RST, or SYN flag is present in the future packet.

In some embodiments, the CPU 115 may also communicate to the GPU 118 to indicate the creation or termination of the session.

Using a method 400 or system as described herein, the CPU 115 of the communication session may be enabled to manage TCP connections by performing a three-way handshake. The handshake may comprise, for example, an exchange of a SYN packet received by the CPU 115, a Synchronize+Acknowledge (SYN+ACK) packet sent by the CPU 115, and an ACK exchange between the peer 109 and the CPU 115.

For example, for a peer 109 seeking to initiate a TCP connection with the computing system 103, the peer 109 may begin by transmitting a SYN packet to the computing system 103. The SYN packet may be received by the NIC 112 of the computing system 103. The SYN packet may comprise data such as an initial sequence number (ISN) generated by the peer. Upon receiving a SYN packet from a peer 109, the CPU 115 may send back a SYN+ACK packet to the peer 109. The SYN+ACK packet may contain the an ISN associated with the computing system 103 and an acknowledgment number. Finally, the peer 109 may send an ACK packet to the computing system 103, acknowledging the SYN+ACK packet.

After completing the three-way handshake, the TCP connection is established, and both devices are ready to exchange data. Once the connection is established, the client and server can exchange data using TCP segments.

Once the CPU 115 completes the three-way handshake to initiate a communication, the CPU 115 instructs the NIC 112 to recognize other packets relating to the communication by writing an entry to the lookup table 227. Next, the flow of packets in the communication not containing exception flags will be sent by the NIC 121 to the GPU receive queue 218.

At 421, packets 300 associated with an established communication, and which do not include a flag exception, are sent to the GPU receive queue 218.

For example, if the peer 109 sending a packet is client device executing a web browser, a packet 300 may contain a request for a web page. If the packet 300 is associated with an established communication according to the lookup table, and if the packet 300 does not contain one or more of a SYN, RST, or FIN flag, the packet 300 will be sent directly to the GPU receive queue 218, the GPU 115 will handle the request, and a response will be sent directly from the GPU 118, without involving the CPU 115.

The GPU 118 may be configured to process each packet stored in the GPU receive queue 218 in an application-specific manner. In some embodiment, the GPU may inspect the TCP header to determine the peer from which the packet originated.

When the peer 109 seeks to close or terminate the communication, the peer 109 may send a closing type of packet to be handled by the CPU 115. The closing type of packet may be identified by the NIC 112 by inspecting the packet to determine the packet contains a FIN flag.

Upon determining the packet contains a FIN flag, the NIC 112 may be configured to store the packet in the CPU receive queue 206.

In general, TCP connections are terminated using a four-way handshake, which involves the following steps. When the peer 109 is ready to close the connection, the peer 109 sends a FIN packet, i.e., a packet including a FIN flag, to the computing system 103, indicating that the peer 109 has finished sending data.

Upon receiving the FIN packet, the NIC 112 may determine the packet contains a FIN flag and in response store the packet in the CPU receive queue. Next, the CPU 115 may handle the FIN packet and send an ACK packet to the peer 109 to acknowledge the receipt of the FIN packet. The CPU 115 may also transmit a FIN packet to the peer 109 and the peer 109 may respond with an ACK packet.

Upon receiving the ACK packet from the peer 109, the NIC 112 may determine the packet contains an ACK flag and in response store the packet in the CPU receive queue. Next, the CPU 115 may handle the ACK packet by updating the lookup table 227 to remove the entry for the communication associated with the ACK packet, or by instructing the NIC 112 to remove the entry for the communication. As a result, the NIC 112 will no longer deliver packets associated with the communication to the GPU receive queue 218.

The present disclosure encompasses embodiments of the method 400 that comprise more or fewer steps than those described above, and/or one or more steps that are different than the steps described above.

The present disclosure encompasses methods with fewer than all of the steps identified in FIG. 4 (and the corresponding description of the method), as well as methods that include additional steps beyond those identified in FIG. 4 (and the corresponding description of the method). The present disclosure also encompasses methods that comprise one or more steps from one method described herein, and one or more steps from another method described herein. Any correlation described herein may be or comprise a registration or any other correlation.

Embodiments of the present disclosure include a computing system, comprising: a first one or more circuits; a second one or more circuits; and a third one or more circuits to: receive a first packet; determine a header of the first packet comprises one or more of a SYN flag, a FIN flag, and a RST flag; in response to determining the header of first packet comprises one or more of the SYN flag, the FIN flag, and the RST flag, deliver the first packet to the first one or more circuits; receive a second packet; determine a header of the second packet does not comprise one or more of the SYN flag, the FIN flag, and the RST flag; and in response to determining the second packet does not comprise the one or more of the SYN flag, the FIN flag, and the RST flag, deliver the second packet to the second one or more circuits.

Aspects of the above computing system include wherein after delivering the first packet to the first one or more circuits, a lookup table is updated.

Aspects of the above computing system include wherein the lookup table is updated based on a response to the first packet generated by the first one or more circuits.

Aspects of the above computing system include wherein prior to delivering the second packet, the third one or more circuits determine one or more of a source of the second packet and a destination of the second packet matches an entry stored in the look-up table.

Aspects of the above computing system include wherein the third one or more circuits determine the header of the first packet comprises the one or more of the SYN flag, the FIN flag, and the RST flag by inspecting the header of the first packet.

Aspects of the above computing system include wherein the first one or more circuits comprises one or more CPUs.

Aspects of the above computing system include wherein the second one or more circuits supports parallel processing.

Aspects of the above computing system include wherein the second one or more circuits comprises one or more GPUs.

Aspects of the above computing system include wherein the third one or more circuits are provided as part of a NIC.

Aspects of the above computing system include wherein the first packet is delivered to the first one or more circuits absent an OS socket.

Aspects of the above computing system include wherein the third one or more circuits are further to transmit, to a node, data stored in a queue by the second one or more processing circuits.

Aspects of the above computing system include wherein the third one or more circuits deliver the second packet to the second one or more circuits by transferring the second packet directly from the third one or more circuits to the second one or more circuits.

Aspects of the above computing system include wherein the second packet is transferred from the third one or more circuits to the second one or more circuits over a PCIe bus.

Aspects of the above computing system include wherein the third one or more circuits are further to: receive a third packet from the first one or more circuits; send the third packet to a node; receive a fourth packet from the second one or more circuits; and send the fourth packet to the node.

Aspects of the above computing system include wherein the node is a TCP peer.

Aspects of the above computing system include wherein the first packet and the second packet are TCP packets.

Aspects of the above computing system include wherein delivering the first packet to the first one or more circuits comprises adding the first packet to a queue associated with the first one or more circuits, and wherein delivering the second packet to the second one or more circuits comprises adding the second packet to a queue associated with the second one or more circuits.

Aspects of the above computing system include wherein the third one or more circuits transmit packets from a plurality of TCP peers directly to the second one or more circuits.

Embodiments include a method, comprising: processing a first packet received by a network device to determine the first packet comprises one or more of a SYN flag, a FIN flag, and a RST flag; in response to determining the first packet comprises one or more of the SYN flag, the FIN flag, and the RST flag, delivering the first packet to first one or more circuits; processing a second packet received by the processing system to determine the second packet does not comprise one or more of the SYN flag, the FIN flag, and the RST flag; and in response to determining the second packet does not comprise one or more of the SYN flag, the FIN flag, and the RST flag, delivering the second packet to second one or more circuits.

Embodiments includes a system comprising: a first one or more circuits to: receive a first packet; determine a header of the first packet comprises one or more of a SYN flag, a FIN flag, and a RST flag; in response to determining the header of first packet comprises one or more of the SYN flag, the FIN flag, and the RST flag, deliver the first packet to a second one or more circuits; receive a second packet; determine a header of the second packet does not comprise one or more of the SYN flag, the FIN flag, and the RST flag; and in response to determining the second packet does not comprise the one or more of the SYN flag, the FIN flag, and the RST flag, deliver the second packet to a third one or more circuits.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

What is claimed is:

1. A computing system, comprising:
a first one or more circuits;
a second one or more circuits; and
a third one or more circuits to:
receive a first packet;
determine a header of the first packet comprises one or more of a synchronize (SYN) flag, a finish (FIN) flag, and a reset (RST) flag;
in response to determining the header of first packet comprises one or more of the SYN flag, the FIN flag, and the RST flag, deliver the first packet to the first one or more circuits;
receive a second packet;
determine a header of the second packet does not comprise one or more of the SYN flag, the FIN flag, and the RST flag; and
in response to determining the second packet does not comprise the one or more of the SYN flag, the FIN flag, and the RST flag, deliver the second packet to the second one or more circuits.

2. The computing system of claim 1, wherein after delivering the first packet to the first one or more circuits, a lookup table is updated.

3. The computing system of claim 2, wherein the lookup table is updated based on a response to the first packet generated by the first one or more circuits.

4. The computing system of claim 2, wherein prior to delivering the second packet, the third one or more circuits determine one or more of a source of the second packet and a destination of the second packet matches an entry stored in the lookup table.

5. The computing system of claim 1, wherein the third one or more circuits determine the header of the first packet comprises the one or more of the SYN flag, the FIN flag, and the RST flag by inspecting the header of the first packet.

6. The computing system of claim 1, wherein the first one or more circuits comprises one or more central processing units (CPUs).

7. The computing system of claim 1, wherein the second one or more circuits supports parallel processing.

8. The computing system of claim 1, wherein the second one or more circuits comprises one or more graphical processing units (GPUs).

9. The computing system of claim 1, wherein the third one or more circuits are provided as part of a network interface controller (NIC).

10. The computing system of claim 1, wherein the first packet is delivered to the first one or more circuits absent an operating system (OS) socket.

11. The computing system of claim 1, wherein the third one or more circuits are further to transmit, to a node, data stored in a queue by the second one or more circuits.

12. The computing system of claim 1, wherein the third one or more circuits deliver the second packet to the second one or more circuits by transferring the second packet directly from the third one or more circuits to the second one or more circuits.

13. The computing system of claim 12, wherein the second packet is transferred from the third one or more circuits to the second one or more circuits over a peripheral component interconnect express (PCIe) bus.

14. The computing system of claim 1, wherein the third one or more circuits are further to:
receive a third packet from the first one or more circuits;
send the third packet to a node;
receive a fourth packet from the second one or more circuits; and
send the fourth packet to the node.

15. The computing system of claim 14, wherein the node is a transmission control protocol (TCP) peer.

16. The computing system of claim 1, wherein the first packet and the second packet are transmission control protocol (TCP) packets.

17. The computing system of claim 1, wherein delivering the first packet to the first one or more circuits comprises adding the first packet to a queue associated with the first one or more circuits, and wherein delivering the second packet to the second one or more circuits comprises adding the second packet to a queue associated with the second one or more circuits.

18. The computing system of claim 1, wherein the third one or more circuits transmit packets from a plurality of TCP peers directly to the second one or more circuits.

19. A method, comprising:
processing a first packet received by a network device to determine the first packet comprises one or more of a synchronize (SYN) flag, a finish (FIN) flag, and a reset (RST) flag;
in response to determining the first packet comprises one or more of the SYN flag, the FIN flag, and the RST flag, delivering the first packet to first one or more circuits;
processing a second packet received by the network device to determine the second packet does not comprise one or more of the SYN flag, the FIN flag, and the RST flag; and
in response to determining the second packet does not comprise one or more of the SYN flag, the FIN flag, and the RST flag, delivering the second packet to second one or more circuits.

20. A system comprising:
a first one or more circuits, a second one or more circuits, and a third one or more circuits, wherein the third one or more circuits:
receive a first packet;
determine a header of the first packet comprises one or more of a synchronize (SYN) flag, a finish (FIN) flag, and a reset (RST) flag;
in response to determining the header of first packet comprises one or more of the SYN flag, the FIN flag, and the RST flag, deliver the first packet to the first one or more circuits;
receive a second packet;
determine a header of the second packet does not comprise one or more of the SYN flag, the FIN flag, and the RST flag; and
in response to determining the second packet does not comprise the one or more of the SYN flag, the FIN flag, and the RST flag, deliver the second packet to the second one or more circuits.
